(19) United States
(12) Patent Application Publication
(10) Pub. No.: US 2018/0012672 A1
(43) Pub. Date: Jan. 11, 2018

(54) System for Reducing Volume of Low-level Radioactive Wastes by Using Superheated Vapor

(71) Applicant: HANKOOK TECHNOLOGY INC., Seoul (KR)

(72) Inventors: Sung Kon KIM, Anyang-si Gyeonggi-do (KR); Yong Bin KIM, Seoul (KR)

(21) Appl. No.: 15/543,399

(22) PCT Filed: Jan. 8, 2016
(86) PCT No.: PCT/KR2016/000183

§ 371 Date: Jul. 13, 2017

(30) Foreign Application Priority Data
Jan. 15, 2015 (KR) 10-2015-0007361
Jan. 15, 2015 (KR) 10-2015-0007375

(51) Int. Cl. G21F 9/32

(52) U.S. Cl. CPC G21F 9/32

(57) ABSTRACT

The present invention relates to a system for reducing a volume by using a superheated vapor generated: from a superheated vapor generator, so as to carbonize and dry low-level radioactive wastes, the system comprising: a reheated vapor generator for generating the superheated vapor by heating mist sprayed from an atomizer, and then discharging the same to a vapor supply pipe; a drying furnace for carbonizing and drying the fed low-level radioactive wastes by primary vapor and the superheated vapor, which are supplied from the reheated vapor generator, and then cooling the carbonized and dried low-level radioactive wastes to a predetermined temperature; a heat exchanger for exchanging the heat of the vapor discharged from a vapor discharge pipe after the low-level radioactive wastes are carbonized and dried in the drying furnace, then supplying the heat-exchanged vapor to the reheated vapor generator through a vapor delivery pipe, discharging, to a condensate water delivery pipe, condensate water generated after the heat exchange of the discharged vapor, and supplying heat-exchanged cooling water to the drying furnace through a cooling water delivery pipe; and a cooling tower for cooling the cooling water, heat-exchanged in the heat exchanger and circulated in the drying furnace, and then delivering the same to the heat exchanger again.

### TECHNICAL FIELD

The present disclosure relates to a system for reducing a volume of a low-level radioactive waste by using superheated vapor, and more particularly, to a system for reducing a volume of a low-level radioactive waste by carbonizing and drying the low-level radioactive waste by using superheated vapor generated by a superheated vapor generator.

### BACKGROUND ART

In general, when liquid is heated under a constant pressure, the temperature of the liquid increases, and when the liquid arrives at a specific temperature, the liquid starts to be evaporated. In this case, even when the liquid is heated again, the liquid and vapor coexists while the temperature thereof is not changed until all the liquid is evaporated. The liquid and the vapor refers to wet saturated vapor, and vapor when all the liquid is evaporated refers to dry saturated vapor. Further, when the dry saturated vapor is heated again, the temperature of the vapor increases. This vapor refers to superheated vapor.

In FIG. 1A, because the superheated vapor, which is obtained by heating saturated vapor under an atmospheric pressure and thus has both latent heat of condensation and sensible heat, has very high potential heat and may be generated under the atmospheric pressure, the superheated vapor may be easily applied to low-pressure high-temperature equipment. Further, in FIG. 1B, the superheated vapor has very excellent heat transfer efficiency due to heating by complex heat transfer of three kinds of heat transfer schemes including convention, radiation, and condensation. Because condensation heat transfer of the superheated vapor cannot be used at a temperature of 100° C. or more, only convection and radiation are used.

In FIG. 1C, a condensation phenomenon occurs on a surface of an object to be heated at an initial time of temperature rising due to changes in a mass and a temperature of the object to be heated, which result from the superheated vapor, and the mass of the object to be heated temporarily increases. Thereafter, as the condensation phenomenon disappears from the surface of the object to be heated at a temperature of 100° C. or more, and an evaporation phenomenon occurs on the surface of the object to be heated, the mass of the object to be heated returns to an original mass and is then gradually reduced.

Further, in FIG. 1D, in connection with a change in a drying speed of the object to be heated under the atmospheric pressure, when the temperature of a heating medium is low, the drying speed by heating air is fast, and when the temperature of the heating medium is high, the drying speed by the superheated vapor is fast. Thus, the superheated vapor has very strong heat transferring force and very high drying capacity that are approximately 10 times of hot air.

Further, the superheated vapor is in a state in which oxygen rarely exists as the vapor is heated under a low oxygen atmosphere. Heating of air by the heating air causes an oxidation reaction because oxygen exists around the air. Thus, the superheated vapor may be usefully applied to heating of a material that may cause an oxidation reaction, and may prevent explosion.

Meanwhile, currently in Korea, a low-level radioactive waste permanent disposal site was constructed and is operated in Gyeongju. However, when all low-level radioactive waste drums stored in a nuclear power plant until now are transferred to the disposal site in addition to the radioactive waste already transferred to the disposal site, an amount of the low-level radioactive wastes may exceed a storage capacity of the disposal site, and thus construction of a new disposal site may have to be planned in advance. Accordingly, reduction in the radioactive wastes generated by the nuclear power plant is earnestly required. Currently, approximately 13,000,000 won is consumed for disposing one radioactive waste drum. From now on, it is expected that radioactive wastes are gradually increased, and disposal costs thereof are gradually increased.

Radioactive wastes generated by the nuclear power plant and to be transferred to the disposal site include concentrated wastes, spent resin, waste filters, dry active wastes, sludge, and the like. Among them, an amount of generated dry active wastes occupies approximately 80% of the total amount of generated radioactive wastes. The dry active wastes include protective clothing, socks, gloves, decontamiantion paper, vinyl, plastic, wood, metals, rubber, heat insulating materials, and the like, and are compressed and stored in a drum.

A considerable amount of the dry active wastes are wastes, volumes of which may be reduced. Thus, when the volumes of the wastes may be reduced, the number of drums to be transferred to the disposal site may be greatly reduced, a lifespan of the disposal site may extend, and disposal costs may be reduced as well, so that efficiency according to operation of the nuclear power plant may be improved.

### DISCLOSURE

### Technical Problem

The present disclosure is conceived to solve the above-described problems, and an aspect of the present disclosure is to reduce volumes of radioactive wastes by drying and carbonizing combustible dry active waste low-level radioactive wastes using superheated vapor and by then compressing the low-level radioactive wastes.

Further, another aspect of the present disclosure is to reduce volumes of radioactive wastes by carbonizing and drying low-level radioactive wastes including combustible dry active wastes, volumes of which may be reduced, by generating and supplying superheated vapor by converting electric energy into thermal energy and by using vapor supplied in a fog state, in a system for reducing volumes of low-level radioactive wastes by carbonizing and drying the low-level radioactive wastes using superheated vapor.

Further, yet another aspect of the present disclosure is to minimize environmental pollution by restraining generation of scattered dust, in a process of drying and carbonizing low-level radioactive wastes using superheated vapor.

### Technical Solution

The present disclosure provides a system for reducing a volume of a low-level radioactive waste using superheated vapor, the system including a reheat steam generator configured to generate superheated steam by heating fog sprayed by a fog machine, and discharge the generated superheated steam to a steam supply tube, a drying furnace configured to carbonize and dry a low-level radioactive waste input into primary steam and the superheated steam supplied by the reheat steam generator, and then cool the carbonized and dried low-level radioactive waste, a heat exchanger configured to heat-exchange steam discharged from a steam discharge tube after the low-level radioactive waste is carbonized and dried in the drying furnace, supply the steam to the reheat steam generator through a steam transfer tube, discharge condensate generated after the discharged steam is heat-exchanged to a condensate transfer tube, and supply heat-exchanged cooling water to the drying furnace through a cooling water transfer tube, and a cooling tower configured to cool the cooling water exchanged by the heat exchanger and circulating in the drying furnace, and then transfer the cooling water to the heat exchanger again.

Further, in the present disclosure, the condensate, generated as the discharged steam and discharged gas generated while the low-level radioactive waste is carbonized and dried in the drying furnace are condensed, may be heat-exchanged by the heat exchanger, may be filtered by a filter, and may be then stored in a condensate storage tank, and the stored condensate may be compressed by a condensate pump, and may be transferred to the fog machine through the condensate transfer tube.

Further, in the present disclosure, the reheat steam generator may generate the superheated vapor using electric energy or may generate the superheated vapor by burning fuel.

Further, in the present disclosure, an opening/closing valve configured to supply or interrupt the cooling water may be installed in the cooling water transfer tube.

Further, in the present disclosure, the reheat steam generator may include a case having an inlet tube formed at an upper portion of the case such that steam introduced from the heat exchanger and steam in a fog state from the fog machine are introduced through the inlet tube and an outlet tube formed at a lower portion of the case such that the superheated steam is discharged through the outlet tube, multi-stage steam generating tubes each having a space in which the superheated vapor is generated using the steam introduced through the inlet tube, one or more electric heaters installed inside the steam generating tubes to convert applied electric energy into thermal energy to heat steam inside the steam generating tubes, and connection tubes connected between the multi-stage steam generating tubes to serve as a passage through which the heated steam is discharged and circulates.

Further, in the present disclosure, the connection tubes may be alternately connected and coupled between the steam generating tubes on the left and right sides in a zigzag form, to provide a path through which the steam flows between the inlet tube and the outlet tube.

Further, in the present disclosure, the steam generating tubes may be fixed and coupled to each other by support brackets.

Further, in the present disclosure, the electric heaters have heating rods protruding from opposite ends of each of the steam generating tubes by a predetermined length to convert electric energy applied from the outside into thermal energy.

### Advantageous Effects

According to the present disclosure, a volume of a low-level radioactive waste is reduced by carbonizing and drying the low-level radioactive waste including combustible dry active wastes by generating low-pressure ultra-high-temperature superheated vapor by a reheat steam generator, and thus, a quarter of drums of middle and low-level radioactive wastes yearly generated in nuclear power plants, so that disposal costs may be reduced, and construction costs may be reduced due to extension of a lifespan of a permanent disposal site. Further, due to extension of the lifespan of the permanent disposal site, stability of operation of the nuclear power plants may be achieved, regional conflicts may be resolved, and additional construction may be delayed due to permanent disposal of radioactive wastes.

### BRIEF DESCRIPTION OF THE DRAWINGS

FIG. 1A-1D illustrates a concept related to general superheated vapor, FIG. 1A is a graph depicting definition of superheated vapor, FIG. 1B illustrates characteristics of the superheated vapor having complex heat transfer, FIG. 1C is a graph depicting changes in a mass and a temperature of an object to be heated by the superheated vapor, and FIG. 1D is a graph depicting drying speeds of the superheated vapor, humid air and dry air under a standard atmospheric pressure;

FIG. 2 is a block diagram illustrating a system for reducing a volume of a low-level radioactive waste using superheated vapor according to an embodiment of the present disclosure;

FIG. 3 is a schematic view illustrating the system for reducing a volume of a low-level radioactive waste using superheated vapor according to the present disclosure;

FIG. 4 is a schematic view illustrating a reheat steam generator according to the present disclosure;

FIG. 5 illustrates an initial process of supplying primary steam generated by the reheat steam generator to a drying furnace to reduce the volume of the low-level radioactive waste using superheated vapor according to the present disclosure;

FIG. 6 illustrates a drying process of supplying the superheated vapor to the drying furnace and performing carbonization, to reduce the volume of the low-level radioactive waste using superheated vapor according to the present disclosure; and

FIG. 7 illustrates a cooling process of cooling the drying furnace by supplying cooling water to the drying furnace, to reduce the volume of the low-level radioactive waste using superheated vapor according to the present disclosure.

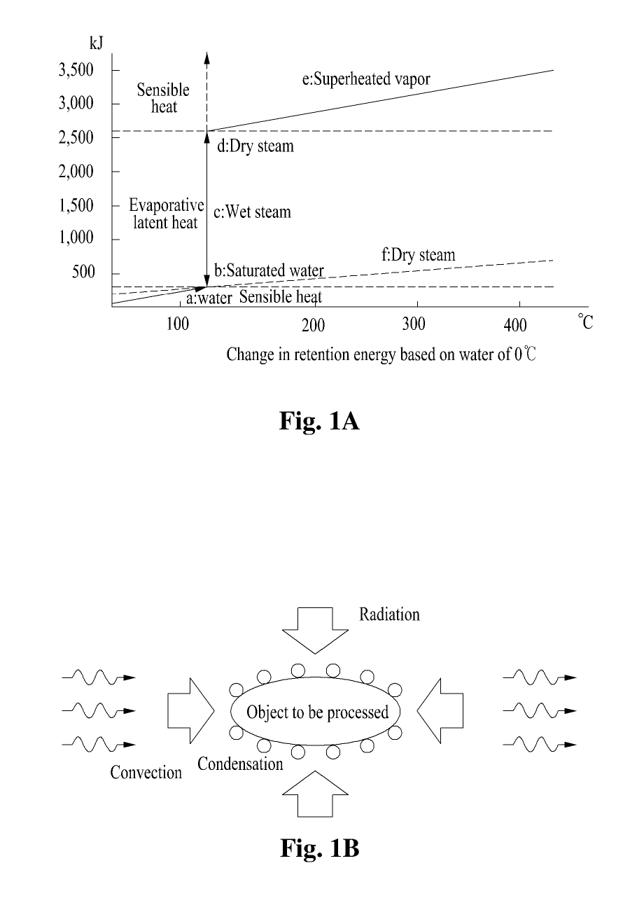

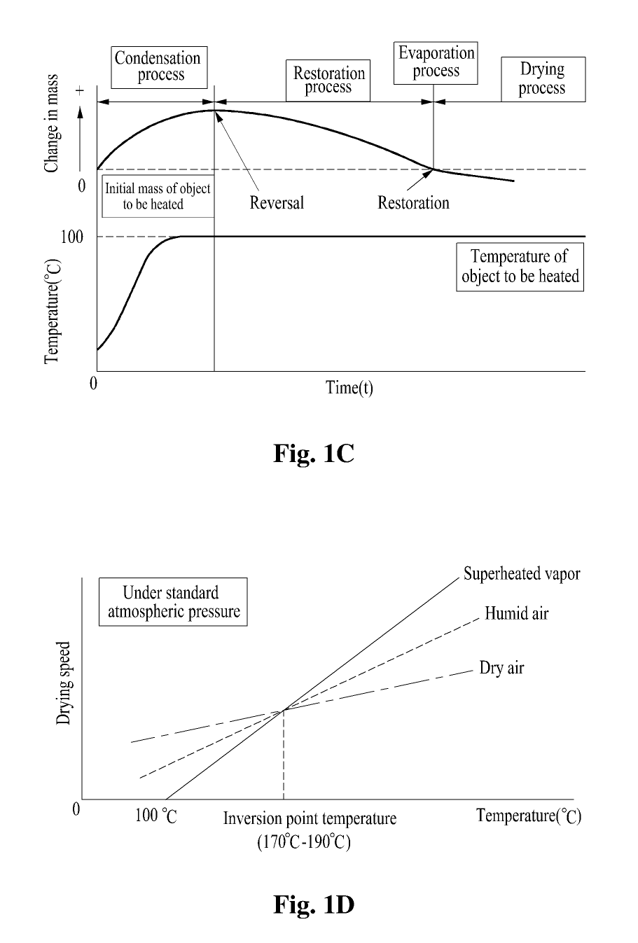

### BEST MODE FOR THE INVENTION

Hereinafter, a system for reducing a volume of a low-level radioactive waste using superheated vapor according to the present disclosure will be described in detail with reference to the accompanying drawings.

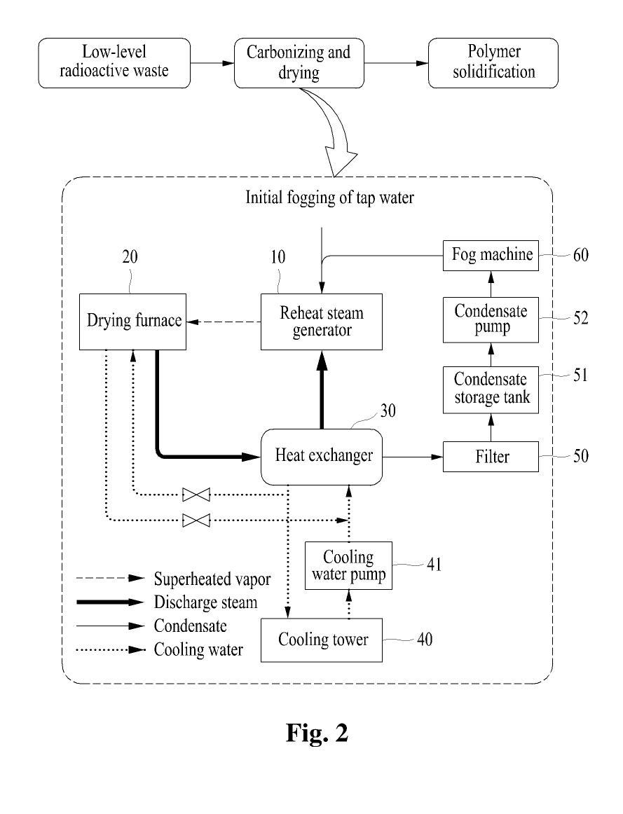

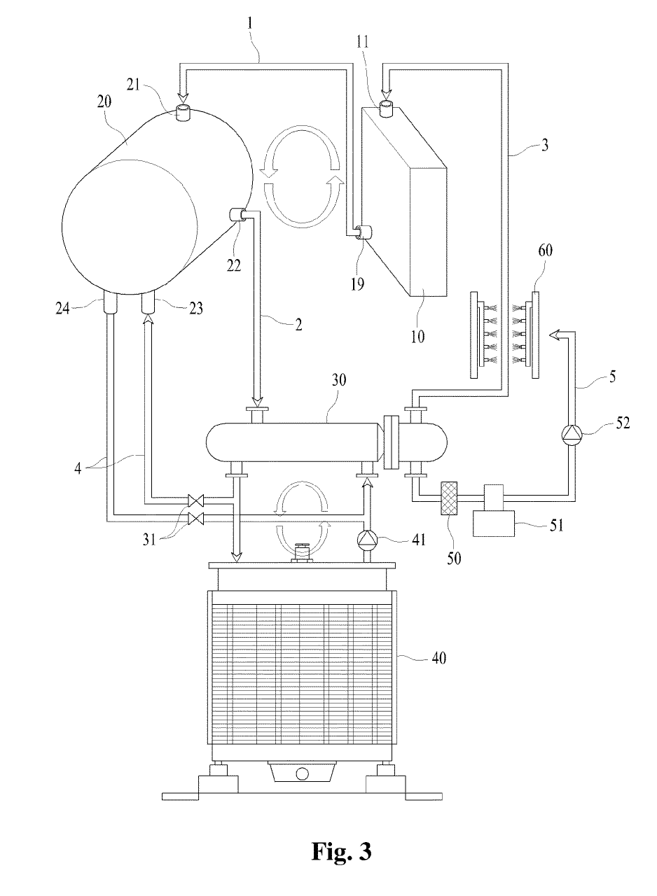

In FIGS. 2 and 3, the present disclosure relates to a system for supplying, to a drying furnace 20, superheated vapor generated by a reheat steam generator 10, carbonizing and drying a low-level radioactive waste input to the drying furnace 20, supplying cooling water heat-exchanged by a cooling tower 40 to the drying furnace 20, storing condensate heat-exchanged by a heat exchanger 30, and then supplying the condensate to a fog machine 60, thereby generating reheat steam by the reheat steam generator 10.

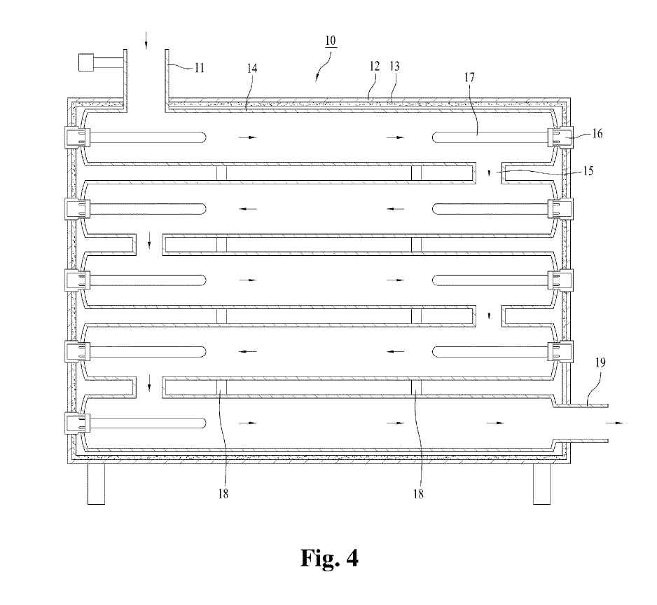

In FIG. 4, the reheat steam generator 10 is configured to discharge low-pressure ultra high-temperature superheated vapor by heating steam in a fog state, which is sprayed by a fog machine 60. In addition, the reheat steam generator 10 is configured to heat internal air at a temperature of approximately 100° C. or more at initial operation, heat and discharge primary steam having a temperature of approximately 150° C. or more, which is supplied in a fog state by the fog machine 60, when the air is heated at a specific temperature, reheat the primary steam reintroduced via the drying furnace 20 such that the primary steam is changed to superheated vapor having a temperature of approximately 600° C. or more, and discharge the superheated vapor to the drying furnace 20.

An inlet tube 11 through which steam introduced from a heat exchanger 30 and steam in a fog state, which is introduced from the fog machine 60, are introduced is coupled to an upper portion of a case 12 of the reheat steam generator 10, and an outlet tube 19 through which the primary steam or the superheated vapor is discharged is coupled to a lower portion of the case 12. An insulator 13 for insulation from the outside is coupled to an inner surface of the case 12. The fact that the inlet tube 11 of the reheat steam is installed at the upper portion and the outlet tube 19 is installed at the lower portion may include an effect that the steam introduced into the reheat steam generator 10 stays in the reheat steam generator 10 as much as possible, and thus the steam may be superheated.

Steam generating tubes 14, which correspond to a space formed to change the steam introduced through the inlet tube 11 to the superheated vapor, are vertically stacked in multiple stages, but may be arranged in a front-rear direction or in a left-right direction as well as in an up-down direction, as needed. The steam generating tube 14 have a cylindrical shape or a shape of a polygonal column, and the number of stacked stages of the steam generating tubes 14 may be determined based on the temperature of the steam. Connection tubes 15, serving as a passage through which the steam heated by the steam generating tubes 14 are discharged and circulate, are connected between the multi-stage steam generating tubes 14. The connection tubes 15 are alternately connected and coupled between the steam generating tubes 14 on the left and right sides in a zigzag form, to maximally increase a path through which the steam flows between the inlet tube 11 and the outlet tube 19. That is, when the upper steam generating tube and the connection tube 15 on a right side of the adjacent lower steam generating tube communicate with each other and are connected to each other, the lower steam generating tube and the connection tube 15 on a left side of the adjacent next lower steam generating tube communicate with each other and are connected to each other. The plurality of steam generating tubes 14 installed in the case 12 in multiple stages are fixed and coupled to the interior of the reheat steam generator 10 through support brackets 18.

One or more electric heaters 16, which are installed inside the steam generating tubes 14, convert applied electric energy into thermal energy to heat the steam inside the steam generating tubes 14. The electric heaters 16 have heating rods 17 protruding inwards from opposite ends of each of the steam generating tubes 14 by a predetermined length to convert the electric energy applied from the outside into the thermal energy. The length and the number of the heating rods 17 may be changed according to the temperature of the discharged steam. It is preferable that a connector may be connected to electric power applied from the outside and an insulator for insulation are employed in the electric heaters 16.

Further, a boiler configured to generate superheated steam by burning fuel may be applied as the reheat steam generator 10.

Next, the drying furnace 20, which is an inner space sealed from the outside, is configured to carbonize and dry the low-level radioactive waste input to the primary steam and the superheated vapor supplied by the reheat steam generator 10 and then cool the carbonized and dried low-level radioactive waste to a specific temperature. An inlet port 21 through which the steam supplied by the reheat steam generator 10 is introduced and an outlet port 22 through which the steam is discharge to the outside are formed in the drying furnace 20. Further, an inlet port 23 through which the steam supplied by the reheat steam generator 30 is introduced and an outlet port 24 through which the steam is discharge to the outside are formed in the drying furnace 20. A spraying tube configured to spray the superheated steam for carbonizing and drying the low-level radioactive waste and a cooling coil configured to the drying furnace 20 are installed in the drying furnace 20.

The heat exchanger 30 is configured to heat-exchange the steam discharged after the low-level radioactive waste is carbonized and dried in the drying furnace 20, and supply the steam to the reheat steam generator 10. Further, the heat exchanger 30 discharges condensate generated after heat exchange of the discharged steam. The heat exchanger 30 supplies cooling water to the drying furnace 20 in which a carbonizing and drying process is completed and heat-exchanges the cooling water discharged from the drying furnace 20. An opening/closing valve 31 configured to supply the cooling water to the drying furnace 20 or interrupt the cooling water from the drying furnace 20 according to the carbonizing and drying process and a cooling process of the drying furnace 20 is installed between the heat exchanger 30 and the drying furnace 20.

The cooling tower 40 is configured to cool the cooling water heat-exchanged by the heat exchanger 30 and circulating in the drying furnace 20, and then transfer the cooling water to the heat exchanger 30 again. Water or refrigerant may be applied as the cooling water. A cooling water pump 41 configured to supply the cooled cooling water to the heat exchanger 30 is installed in the cool tower 40.

Discharge steam and discharge gas generated while the low-level radioactive waste is carbonized and dried in the drying furnace 20 are discharged as condensate is generated by the heat exchanger 30 due to condensation by the heat exchange. The condensate discharged from the heat exchanger 30 is filtered through a filter 50 such that foreign substances are removed, and is then stored in a condensate storage tank 51. A condensate pump 52 compresses the condensate stored in the condensate storage tank 51 to transfer the condensate to the fog machine through a condensate transfer pipe 5.

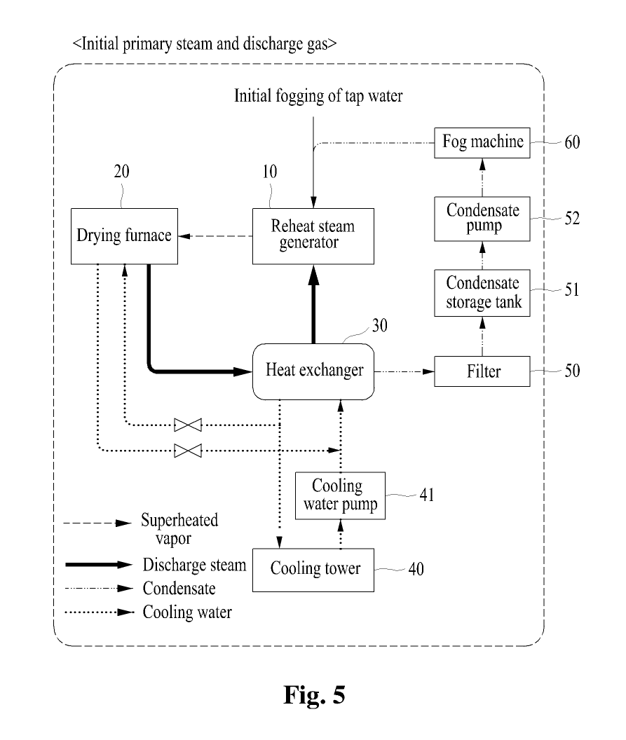

An effect of the system for reducing a volume of a low-level radioactive waste using superheated steam according to the present disclosure will be described with reference to FIGS. 5 to 7.

First, in FIG. 5, in a process of generating primary steam, the drying furnace 20 is opened, and the low-level radioactive waste to be carbonized and dried is input into the drying furnace 20. Further, the reheat steam generator 10 is operated to heat the temperature of air inside the steam generating tubes 14 up to a temperature of approximately 100° C. or more. Next, the fog machine 60 is operated to supply the steam in a fog state to the inlet tube 11 of the reheat steam generator 10. At this time, tap water is supplied to the fog machine 60. Thereafter, the condensate separated from the discharge steam discharged from the drying furnace 20 is supplied to the fog machine 60.

The steam in a fog state, which is supplied from the fog machine 60, is changed to the primary steam having a temperature of approximately 150° C. or more in the reheat steam generator 10 by the air heated to a specific temperature and the heating rods 17 of the electric heaters 16. The primary steam is input from the outlet tube 19 of the reheat steam generator 10 through a steam supply tube 1 to the inlet port 21 of the drying furnace 20. The primary steam input to the drying furnace 20 is applied to the low-level radioactive waste, and discharge steam and gas are generated from the low-level radioactive waste, and are discharged to a steam discharge tube 2 through the discharge port 22.

The discharge steam and gas including the primary steam discharged from the steam discharge tube 2 are input to the heat exchanger 30 and are heat-exchanged in the heat exchanger 30. The heat-exchanged discharge steam and gas are supplied to the inlet tube 11 of the reheat steam generator through a steam transfer tube 3. At this time, the condensate is generated while the discharge steam is heat-exchanged in the heat exchanger 30 and is discharged to a condensate transfer tube 5. The condensate is filtered by a filter 50 such that foreign substances are removed therefrom, and is then stored in the condensate storage tank 51. The condensate stored in the condensate storage tank 51 is supplied to the fog machine 60 through the condensate transfer tube 5 by compression of the condensate pump 52 and is changed to steam in a fog state.

Thus, the discharge steam including the primary steam input into the reheat steam generator 10 through the steam transfer tube 3 is supplied to the interior through the inlet tube 11 of the reheat steam generator 10 together with steam fogged by the fog machine 60.

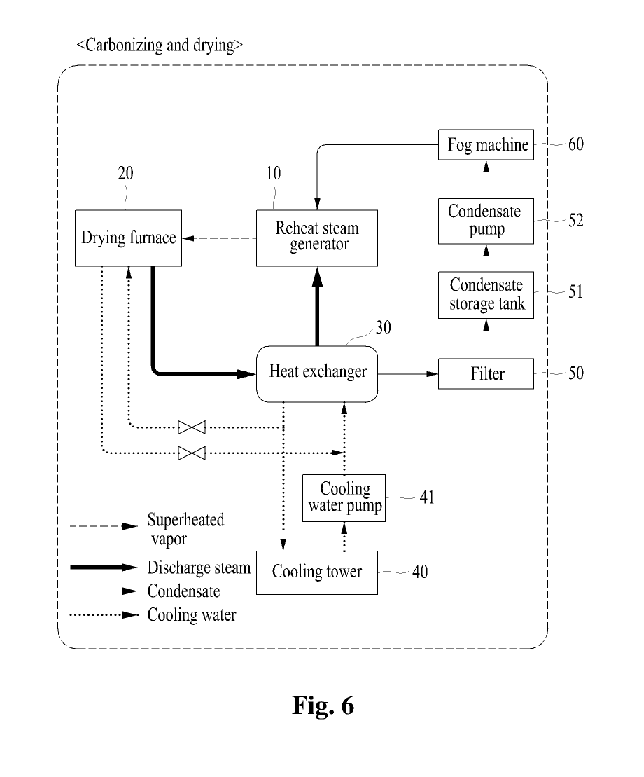

Next, in FIG. 6, in the carbonizing and drying process, the reheat steam generator 10 allows the discharge steam and the steam supplied in a fog state to pass through the multi-stage steam generating tubes 14 in which the plurality of electric heaters 16 are installed, to generate the superheated vapor having a temperature of approximately 600° C. or more. The superheated steam generated by the reheat steam generator 10 is supplied to the drying furnace 20 through the steam supply tube 1 to carbonize and dry the low-level radioactive waste input to the drying furnace 20. At this time, the superheated steam, which is low-oxygen low-pressure ultra-high-temperature steam, carbonizes the low-level radioactive waste.

Thus, the carbonizing and drying process in which the superheated steam generated by the reheat steam generator 10 is supplied to the drying furnace 20 through the steam supply tube 1 to carbonize and dry the low-level radioactive waste, and the discharge steam supplied from the drying furnace 20 through the steam discharge tube via the heat exchanger 30 to the steam transfer tube 3 and the fog machine 60 is reheated by the reheat steam generator 10, and is then supplied to the drying furnace again is performed for a specific time period.

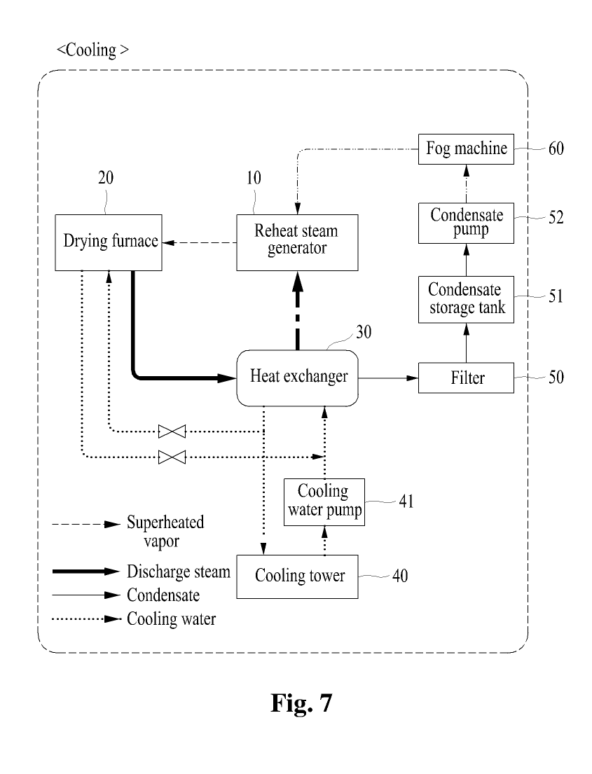

In FIG. 7, in the cooling process, after the low-level radioactive waste input into the drying furnace 20 is completely carbonized and dried, an operation of the reheat steam generator 10 stops such that the superheated steam is not supplied to the drying furnace 20 through the steam supply tube 1. At this time, an operation of the condensate pump 52 stops so that the condensate is not supplied to the condensate transfer tube 5, and the fog machine 60 also stops.

Further, the opening/closing valve 31 coupled to a cooling water transfer tube 4 connected between the heat exchanger 30 and the drying furnace 20 is opened, and the cooling water pump 41 coupled to the cooling water transfer tube 4 connected between the heat exchanger 30 and the cooling tower 40 is operated. Thus, the cooling water is supplied from the heat exchanger 30 via the cooling water transfer tube 4 to the inlet port 23 of the drying furnace 20 and circulates to the cooling coil installed inside the drying furnace 20. The temperature of the interior of the drying furnace 20 is lowered by the cooling water. This is to cool the low-level radioactive waste down to a temperature of 150° C. or less because the low-level radioactive waste carbonized and dried in the drying furnace 20 by the superheated steam has a temperature of approximately 150° C. or more, and thus may be ignited due to contact with oxygen when being suddenly exposed to the outside.

The cooling water passing through the cooling coil inside the drying furnace 20 is reintroduced into the heat exchanger 30 through the cooling water transfer tube connected to the outlet port 24. Further, the cooling water is supplied to the cooling tower 40, is cooled to a specific temperature or less and circulates in the cooling tower 40, is supplied to the heat exchanger 30, and is then resupplied to the drying furnace 20 through the cooling water transfer tube 4.

When the temperature of the low-level radioactive waste input into the drying furnace 20 through the cooling process is changed to a specific temperature or less, the low-level radioactive waste is completely carbonized and dried. The low-level radioactive waste is recovered in a state in which a volume of the low-level radioactive waste is reduced by the carbonizing and drying. Thereafter, the recovered low-level radioactive waste is loaded on a drum through a polymer solidification treatment process, and is post-processed in a middle and low-level radioactive waste permanent disposal site.

Thus, as the volume is reduced due to disposal of the low-level radioactive waste, a storage space of the disposal site may be secured, and disposal costs may be reduced. In addition, as the system for reducing a volume of a low-level radioactive waste using superheated vapor according to the present disclosure is applied, waste heat of the total discharge steam is recovered so that the temperature of input steam may be increased, the temperature of the drying furnace may be equalized so that consumption of electric energy may be reduced, transfer equipment and plumbing equipment are minimized so that maintenance costs may be reduced, and a high-efficiency motor is applied to main equipment and an inverter suitable for characteristics of the motor is applied and controlled so that power costs may be reduced. Further, the system for reducing a volume of a low-level radioactive waste using superheated steam has an advantage in that middle and 1,800 to 1,900 drums of low-level solid radioactive wastes are yearly generated in all nuclear power plants operated in Korea, and among them, 1,400 to 1,500 drums of dry active wastes are generated, so that approximately a quarter of the total amount of radioactive wastes may be reduced, and processing costs may be reduced.

While the present disclosure has been described with respect to the specific embodiments, it will be apparent to those skilled in the art that various changes and modifications may be made without departing from the spirit and scope of the invention as defined in the following claims.

### INDUSTRIAL AVAILABILITY

The present disclosure has an industrial availability in that a volume of a low-level radioactive waste is reduced by carbonizing and drying the low-level radioactive waste including combustible dry active wastes by generating low-pressure ultra-high-temperature superheated vapor by a reheat steam generator, and thus, a quarter of drums of middle and low-level radioactive wastes yearly generated in nuclear power plants, so that a storage space according to disposal of the radioactive wastes may be secured, disposal costs may be reduced, and construction costs may be reduced due to extension of a lifespan of a permanent disposal site.

1. A system for reducing a volume of a low-level radioactive waste using superheated vapor, the system comprising:
a reheat steam generator configured to generate superheated steam by heating fog sprayed by a fog machine, and discharge the generated superheated steam to a steam supply tube;
a drying furnace configured to carbonize and dry a low-level radioactive waste input into primary steam and the superheated steam supplied by the reheat steam generator, and then cool the carbonized and dried low-level radioactive waste;
a heat exchanger configured to heat-exchange steam discharged from a steam discharge tube after the low-level radioactive waste is carbonized and dried in the drying furnace, supply the steam to the reheat steam generator through a steam transfer tube, discharge condensate generated after the discharged steam is heat-exchanged to a condensate transfer tube, and supply heat-exchanged cooling water to the drying furnace through a cooling water transfer tube; and
a cooling tower configured to cool the cooling water exchanged by the heat exchanger and circulating in the drying furnace, and then transfer the cooling water to the heat exchanger again.

2. The system of claim 1, wherein the condensate, generated as the discharged steam and discharged gas generated while the low-level radioactive waste is carbonized and dried in the drying furnace are condensed, is heat-exchanged by the heat exchanger, is filtered by a filter, and is then stored in a condensate storage tank, and the stored condensate is compressed by a condensate pump, and is transferred to the fog machine through the condensate transfer tube.

3. The system of claim 1, wherein the reheat steam generator generates the superheated vapor using electric energy or generates the superheated vapor by burning fuel.

4. The system of claim 1, wherein an opening/closing valve configured to supply or interrupt the cooling water is installed in the cooling water transfer tube.

5. The system of claim 1, wherein the reheat steam generator comprises,
a case having an inlet tube formed at an upper portion of the case such that steam introduced from the heat exchanger and steam in a fog state from the fog machine are introduced through the inlet tube and an outlet tube formed at a lower portion of the case such that the superheated steam is discharged through the outlet tube,
multi-stage steam generating tubes each having a space in which the superheated vapor is generated using the steam introduced through the inlet tube,
one or more electric heaters installed inside the steam generating tubes to convert applied electric energy into thermal energy to heat steam inside the steam generating tubes, and
connection tubes connected between the multi-stage steam generating tubes to serve as a passage through which the heated steam is discharged and circulates.

6. The system of claim 5, wherein the connection tubes are alternately connected and coupled between the steam generating tubes on the left and right sides in a zigzag form, to provide a path through which the steam flows between the inlet tube and the outlet tube.

7. The system of claim 5, wherein the steam generating tubes are fixed and coupled to each other by support brackets.

8. The system of claim 5, wherein the electric heaters have heating rods protruding from opposite ends of each of the steam generating tubes by a predetermined length to convert electric energy applied from the outside into thermal energy.
